(19) United States
(12) Patent Application Publication
(10) Pub. No.: US 2002/0188472 A1
(43) Pub. Date: Dec. 12, 2002

(54) Medical data management method and medical data management system

(75) Inventors: Yoshimasa Fujisaka, Aichi (JP); Norimasa Hayashi, Aichi (JP)

Correspondence Address: SUGHRUE MION, PLLC, 2100 PENNSYLVANIA AVENUE, N.W., WASHINGTON, DC, 20037, US

(73) Assignee: NIDEK CO., LTD.

(21) Appl. No.: 10/160,032

(22) Filed: Jun. 4, 2002

(30) Foreign Application Priority Data
Jun. 5, 2001 (JP) P2001-169341

(51) Int. Cl. G06F 17/60

(52) U.S. Cl. 705/2

(57) ABSTRACT

A medical data management method comprising the steps of: providing a personal identification information to a portable communication terminal of a patient via a communications channel; and determining whether or not medical data of the patient, received from a communication terminal of a medical institute via the communications channel, can be accepted, based on the personal identification information and a corporate identification information received in association therewith.

### BACKGROUND OF THE INVENTION

The present invention relates to a medical data management method and medical data management system for centralizing storage and management of medical data that pertain to a patient and have been obtained in a plurality of medical institutions, such as hospitals.

There has already been known a medical data management system which stores and manages medical data pertaining to a patient. The management system employs a LAN constructed within a single hospital, and medical data are exchanged by way of the LAN. In another known management system, a patient stores medical data into an IC card or the like and a plurality of hospitals share the medical data.

However, the former system encounters difficulty in providing another hospital or a like institution with the medical data. The latter system enables sharing of data among a plurality of hospitals or the like; however, the patient must carry the IC card or the like when consulting a doctor. Moreover, difficulty is encountered when the patient attempts to ascertain contents of the medical data stored in the IC card or the like.

In light of the drawbacks in the related art, the challenge to be met by the invention is to provide a medical data management method and medical data management system which obviate the need for a patient to carry a material having stored therein medical data (i.e., a medium), such as an IC card, and which enable safe sharing of medical data among a plurality of medical institutions. Another challenge to be met by the invention is to provide a medical data management method and medical data management system which enable a patient to ascertain contents of medical data by himself/herself.

### SUMMARY OF THE INVENTION

To solve the drawbacks, the invention is characterized by comprising the following.

(1) A medical data management method comprising the steps of:

providing a personal identification information to a portable communication terminal of a patient via a communications channel; and

determining whether or not medical data of the patient, received from a communication terminal of a medical institute via the communications channel, can be accepted, based on the personal identification information and a corporate identification information received in association therewith.

(2) The method of (1), further comprising the step of:

providing the corporate identification information to the communications terminal of the medical institute via the communications channel.

(3) The method of (1), further comprising the steps of:

sending a confirmation information for confirming acceptance of the medial data, to the portable communication terminal of the patient via the communications channel in case it is determined that the received medical data can be accepted; and

accepting and storing the received medical data in case an information that permits the acceptance of the medical data is received from the portable communication terminal of the patient via the communications channel.

(4) The method of (3), further comprising the step of:

returning the received medical data to the communication terminal of the medical institute via the communications channel in case an information that does not permit the acceptance of the medical data is received from the portable communication terminal of the patient via the communications channel.

(5) The method of (1), further comprising the step of:

in case it is determined that the received medical data cannot be accepted, sending an information indicative of that determination to at least one of the communication terminal of the medical institute and the portable communication terminal of the patient via the communications channel.

(6) A medical data management system comprising a computer in which a software programmed to execute the medial data management method of (1) is installed.

(7) A medical data management method comprising the steps of:

providing a personal identification information to a portable communication terminal of a patient via a communications channel; and

determining whether or not stored and managed medical data of the patient can be sent to a communication terminal of a medical institute via the communications channel, based on the personal identification information and a corporate identification information received from the communication terminal of the medical institute via the communications channel.

(8) The method of (7), further comprising the step of:

providing the corporate identification information to the communication terminal of the medical institute via the communications channel.

(9) The method of (7), further comprising the steps of:

sending a confirmation information for confirming sending of the stored and managed medical data, to the portable communication terminal of the patient via the communications channel in case it is determined that the stored and managed medical data can be sent; and

sending the stored and managed medical data to the communication terminal of the medical institute via the communications channel in case an information that permits the sending of the medical data is received from the portable communication terminal of the patient via the communications channel.

(10) The method of (9), further comprising the step of:

in case an information that refuses the sending of the medical data is received from the portable communication terminal of the patient, sending an information indicative of refusal to the communication terminal of the medical institute via the communications channel.

(11) The method of (7), further comprising the step of:

in case it is determined that the stored and managed medical data cannot be sent, sending an information indicative of that determination to at least one of the communication terminal of the medical institute and the portable communication terminal of the patient via the communications channel.

(12) A medical data management system comprising a computer in which a software programmed to execute the medical data management method of (7) is installed.

(13) A medical data management system comprising:

first providing means for providing a personal identification information to a portable communication terminal of a patient via a communications channel;

determining means for determining whether or not medical data of the patient, received from a communication terminal of a medical institute via the communications channel, can be accepted, based on the personal identification information and a corporate identification information received in association therewith; and

managing means for storing and managing the received medical data of the patient in association with the personal identification information.

(14) The system of (13), further comprising:

second providing means for providing the corporate identification information to the communication terminal of the medical institute via the communications channel.

(15) The system of (13), further comprising:

sending means for sending a confirmation information for confirming acceptance of the medial data, to the portable communication terminal of the patient via the communications channel in case it is determined that the received medical data can be accepted,

wherein the managing means stores and manages the received medical data in case an information that permits the acceptance of the medical data is received from the portable communication terminal of the patient via the communications channel.

(16) A medical data management system comprising:

first providing means for providing a personal identification information to a portable communication terminal of a patient via a communications channel;

determining means for determining whether or not stored and managed medical data of the patient can be sent to a communication terminal of a medical institute via the communications channel, based on the personal identification information and a corporate identification information received from the communication terminal of the medical institute via the communications channel; and

first sending means for sending the stored and managed medical data to the communication terminal of the medical institute via the communications channel.

(17) The system of (16), further comprising the step of:

second providing means for providing the corporate identification information to the communication terminal of the medical institute via the communications channel.

(18) The system of (16), further comprising the steps of:

second sending means for sending a confirmation information for confirming sending of the stored and managed medical data, to the portable communication terminal of the patient via the communications channel in case it is determined that the stored and managed medical data can be sent,

wherein the first sending means sends the stored and managed medical data to the communication terminal of the medical institute via the communications channel in case an information that permits the sending of the medical data is received from the portable communication terminal of the patient via the communications channel.

The present disclosure relates to the subject matter contained in Japanese patent application No. 2001-169341 (filed on Jun. 5, 2001), which is expressly incorporated herein by reference in its entirety.

### BRIEF DESCRIPTION OF THE DRAWINGS

FIG. 1 is a schematic block diagram of a medical data management system according to an embodiment of the invention;

FIG. 2 is a flowchart showing the flow of operation up to a step where medical data pertaining to a patient is recorded in a data management institution;

FIG. 3 is a diagram showing an operation for acquiring personal identification information and corporate identification information; and

FIG. 4 is a flowchart showing flow of operation up to a step where medical data pertaining to a patient is received from the data management institution.

### DESCRIPTION OF THE PREFERRED EMBODIMENT

An embodiment of the invention will be described by reference to the drawings.

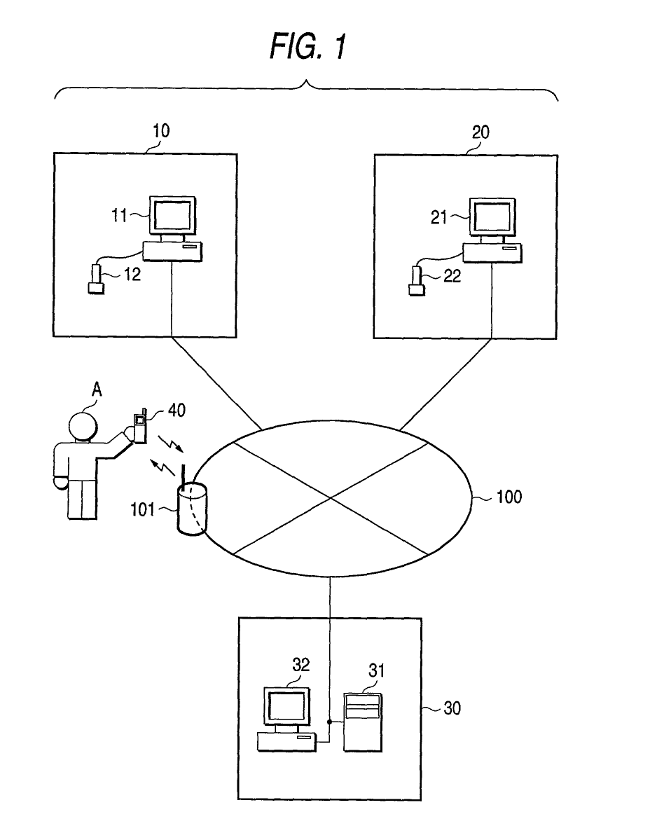

FIG. 1 is a schematic block diagram of a medical data management system according to the embodiment. As shown in the drawing, reference character A denotes a patient. The patient A carries a portable cellular phone 40, which is a kind of portable communication terminal. The embodiment employs the portable cellular phone 40, but the portable communication terminal is not limited to the portable cellular phone; any type of communication terminal device can be used, so long as the device enables acquisition of data by way of a communications channel and is portable at all times. For instance, the device may be a personal handy-phone system (PHS), a personal digital assistant (PDA), or the like.

Reference numerals 10, 20 designate hospitals, which are kinds of medical institutions. Set in the hospitals 10, 20 are personal computers 11, 21 (hereinafter abbreviated as “PCs”) as communication terminals which prepare and record medical data pertaining to the patient A and acquire medical data pertaining to the patient A from a management server 31 to be described later. The PC 11 is equipped with a bar code reader 12, and the PC 21 is equipped with a bar code reader 22. The bar code reader is used for reading personal identification information about the patient A from the portable cellular phone 40 [in the embodiment, information converted into a barcode (identification number) is used as personal identification information].

Reference numeral 30 designates a data management institution, in which are installed a management server 31 for collectively storing and managing medical data pertaining to a plurality of patients, and a PC 32. A medical institution, such as a hospital, may serve as the data management institution 30. However, the data management institution collectively stores and manages medical data pertaining to a plurality of patients residing in different addresses, and hence the data management institution is desirably a third-party institution which has no direct relationship with patients and medical institutions such as hospitals.

Reference numeral 100 designates a communications channel interconnecting communication terminals, the management server 31, and the PC 32. The embodiment employs the Internet as the communications channel 100. The communications channel 100 is not limited to the Internet, and any channel or line can be used, so long as it enables interactive communication of data. Reference numeral 101 designates a cell site provided on the communications channel 100. The cell site 101 employed in the embodiment plays the role of transmitting data from the data management institution 30 to the portable cellular phone 40 of the patient A by means of radio communication.

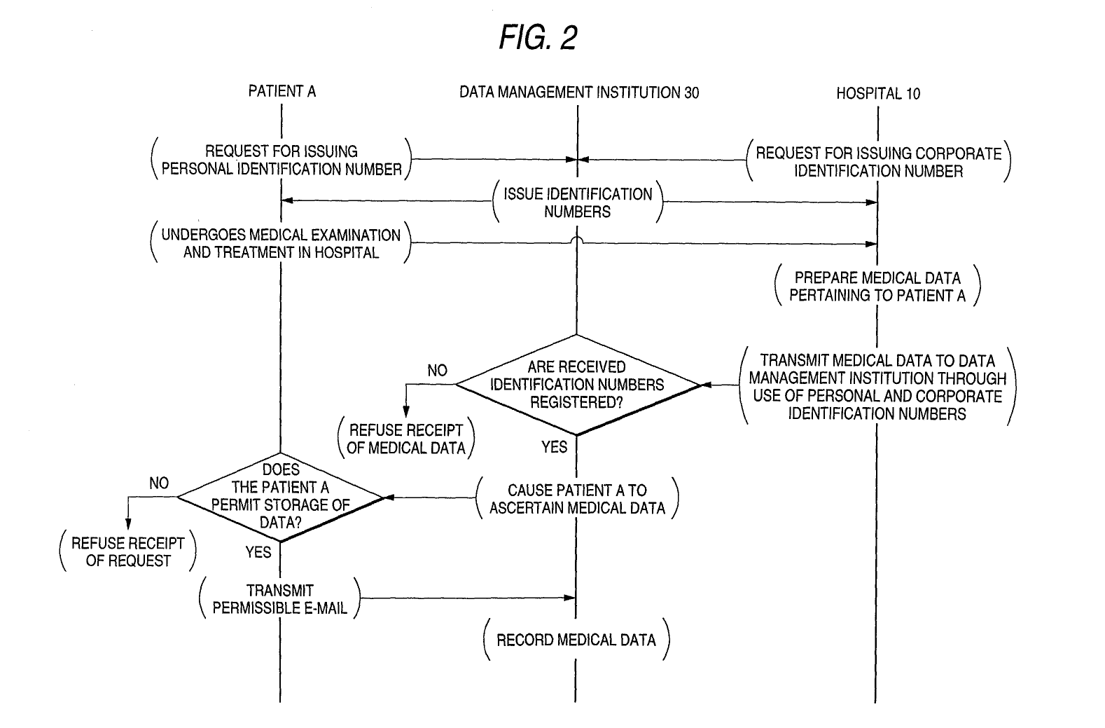

The operation of the medical data management system of the foregoing configuration will be described by reference to FIGS. 2, 3, and 4. First, there will be described procedures up to a step in which the patient A and the hospitals 10, 20 acquire personal identification information and corporate identification information from the data management institution 30. Next, there will be described a procedure by which the data management institution 30 stores and manages the medical data pertaining to the patient A sent from the hospital 10. Further, there will be described a procedure by which the hospital 20 acquires the medical data stored and managed by the data management institution 30.

<Acquisition of Identification Number>

The patient A acquires a personal identification number (information) from the data management institution 30 in advance. The patient A submits, to the data management institution 30, personal information (identification information), such as a driver's license number, a health insurance number, a mail address of the portable cellular phone 40 owned by the patient A, or a phone number, thereby requesting issuance of the personal identification number to the data management institution 30. Upon verification of the identity of the patient A through use of the thus-submitted personal information, the data management institution 30 registers the personal identification number of the patient A in the management server 31. Subsequently, the thus-registered personal identification number is appended to an E-mail as image data pertaining to a bar code, and the E-mail is transmitted from the PC 32 or the management server 31. In accordance with an E-mail address, the thus-transmitted data are sent to the portable cellular phone 40 of the patient A from the cell site 101. When the E-mail has been delivered to the portable cellular phone 40 from the data management institution 30, the patient A operates the portable cellular phone 40, to thereby store into the memory of the portable cellular phone 40 the image data pertaining to the bar code appended to the E-mail. Here, the patient A may directly visit the data management institution 30 for submitting personal information or may send the information to the institution by means of postal service or facsimile. However, personal information (or a request for issuing personal identification number) is desirably sent to the institution by means of an E-mail, a Web Site, or the like.

In the embodiment, the personal identification number is sent to the portable cellular phone 40 while being appended to an E-mail. However, delivery of the personal identification number is not limited to such a manner. For instance, the patient A who has received a communication pertaining to issuance of a personal identification number from, e.g., the data management institution 30, may connect with the management server 31 by way of the cell site 101 by use of the portable cellular phone 40, to thereby download image data pertaining to a bar code into the memory of the portable cellular phone 40. Alternatively, issuance of personal identification numbers to patients may be performed by medical institutions (e.g., the hospitals 10, 20) or a like institution.

The hospitals 10, 20 also submit to the data management institution 30 information which enables identification of or specifies E-mail addresses of the PCs 11, 21, thereby requesting issuance of a corporate identification number (information) to the data management institution 30. After having completed identification on the basis of the information supplied from the hospitals 10, 20, the data management institution 30 registers the corporate identification number into the management server 31, thereby delivering the corporate identification number to the hospitals 10, 20 in the form of a bar code. The bar code to be sent to the hospitals 10, 20 may be transmitted as image data to the PCs 11, 21 by way of the communication channel 100. Alternatively, the bar code may be sent to the hospitals 10, 20 while being printed on paper, by means of postal service or the like.

By means of the foregoing procedures, the patient A and the hospitals 10, 20 have acquired beforehand from the data management institution 30 identification numbers for verifying identification.

<Storage of Medical Data>

Next, there will be described procedures up to a step in which the patient A receives consultation (medical advice) and treatment at the hospital 10 and in which the resultant medical data are stored in the data management institution 30.

After having received a personal identification number from the data management institution 30, the patient A visits the hospital 10 for consultation and treatment. After the patient A has received consultation and treatment in the hospital 10, through use of the PC 11 the hospital 10 prepares, as an electronic clinical chart, medical data pertaining to the name of the doctor, the name of the patient, the date and time, details of the medical examination, details of medical treatment, and medical expense incurred in the course of medical examination and treatment. Medical image data, such as an X-ray photograph, a fundus image or the like, may be captured by the PC 11 as digital data through use of an unillustrated scanner or digital camera.

The hospital 10 performs a transmission operation for having the thus-prepared medical data recorded and managed by the data management institution 30. The hospital 10 accesses the management server 31 of the data management institution 30 by way of the PC 11 and the communication channel 100. In order to permit acceptance (i.e., transmission) of the medical data, the management server 31 requests transmission of a personal identification number and a corporate identification number.

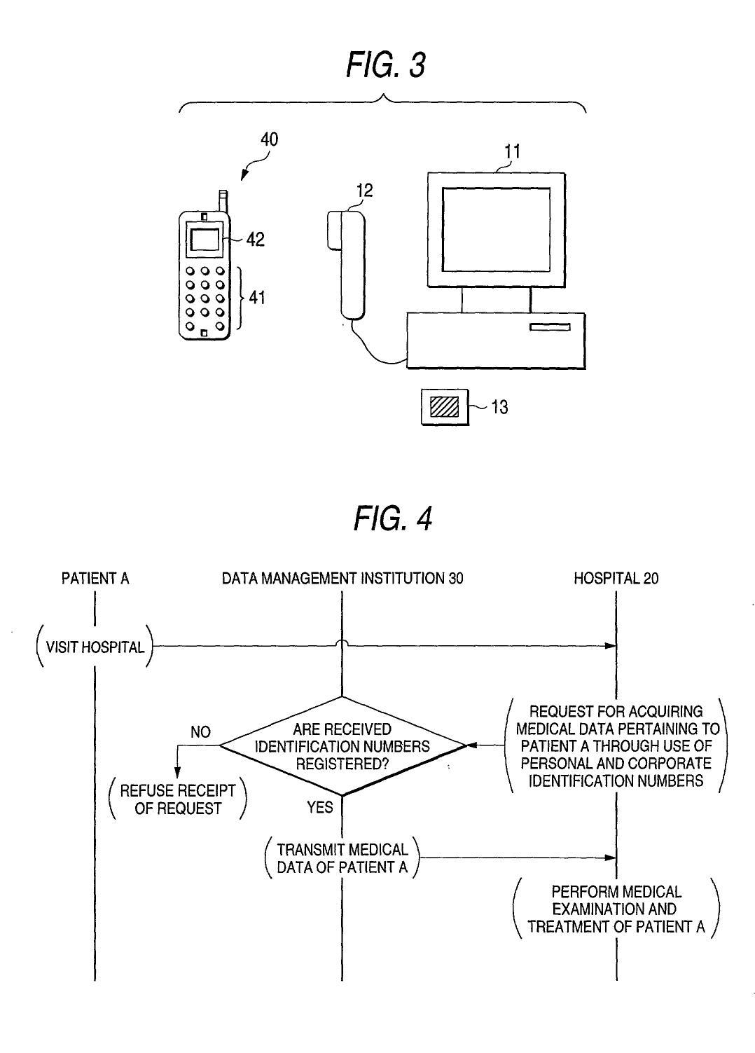

In order to cause the management server 31 to store medical data, a personal identification number must be submitted. Hence, the hospital 10 requests the patient A to submit a personal identification number. The patient A displays (outputs) the image data pertaining to a bar code stored in the memory of the portable cellular phone 40, by means of operation of an operation section 41 of the portable cellular phone 40 (see FIG. 3). The hospital 10 reads the bar code displayed on a liquid-crystal screen 43 of the portable cellular phone 40 through use of the bar code reader 12. The personal identification number of the patient A is transmitted to the management server 31 by way of the PC 11. Similarly, the hospital 10 reads the bar code 13 given as a corporate identification number through use of the bar code reader 12 and sends the identification number to the management server 31 by way of the PC 11. In case where image data of the bar code is given as the corporate identification number, the data can be preliminarily stored in the PC 11 to be transmitted to the management server 31.

The management server 31 of the data management institution 30 checks whether or not the two identification numbers that have been received (personal and corporate identification numbers) are registered. If the two identification numbers are determined to be registered in the management server 31, the management server 30 temporarily receives the medical data sent from the hospital 10. If one or both of the two identification numbers is not registered, acceptance of medical data is refused, and notification of refusal is transmitted from the data management institution 30 to the hospital 10 by way of the communication channel 100. Similarly, an E-mail stating refusal of medical data is transmitted to the portable cellular phone 40.

If the two identification numbers are registered in the data management institution 30 and if the medical data have been accepted, the data management institution 30 performs an operation for checking contents of the medical data. The data management institution 30 sends an E-mail stating that the received medical data can be stored to the portable cellular phone 40 of the patient A. The E-mail provides the name of a hospital where the patient A has undergone medical examination and treatment, the name of the doctor in charge of the patient A, the date and time, details of medical examination and those of medical treatment, and medical expense incurred in the course of medical examination and treatment.

The patient A ascertains the E-mail sent to the portable cellular phone 40 from the data management institution 30. If the contents described in the E-mail are correct, the patient A returns to the data management institution 30 an E-mail for enabling recording of medical data. If the medical data described in the E-mail include errors or are unknown, an E-mail stating that the medical data cannot be stored is returned.

If a permission signal has been returned by the patient A, the data management institution 30 stores and manages the medical data pertaining to the patient A transmitted from the hospital 10. In contrast, if a signal refusing permission has been returned by the patient A, the data management institution 30 reports to the hospital 10 refusal of storage of the received medical data, returning the medical data.

As mentioned above, a personal identification number of the patient and a corporate identification number of the hospital must be transmitted when medical data are transmitted from the hospital to the data management institution 30. Hence, erroneous transmission of the medical data can be inhibited. By means of causing the patient to ascertain the medical data transmitted to the data management institution 30 before storage of the data, the patient can ascertain by himself/herself the medical data to be recorded. Hence, storage of erroneous medical data can be inhibited.

<Acquisition of Medical Data>

Next will be described procedures by which the hospital 20 acquires medical data pertaining to the patient A.

The following description is based on the assumption that the patient A visits another hospital 20 for medical examination and treatment after having undergone medical examination and treatment in the hospital 10 and that the medical data have been stored in the data management institution 30.

The patient A passes through reception at the hospital 20 for medical examination and treatment. The hospital 20 accesses the management server 31 of the data management institution 30, through use of the PC 21 and by way of the communications line 100. In order to permit acquisition of the medical data pertaining to the patient A, the management server 31 requests transmission of the personal identification number of the patient A and the corporate identification number of the hospital 20.

The hospital 20 requests the patient A to submit a personal identification number. The patient A displays (outputs) on the liquid-crystal screen 42 of the portable cellular phone 40 image data pertaining to a bar code. Through use of the bar code reader 22, the hospital 20 reads the bar code displayed on the liquid-crystal screen 42 of the portable cellular phone 40. The thus-read personal identification number of the patient A is transmitted to the management server 31 from the PC 21. Similarly, through use of the bar code reader 22 the hospital 20 reads a bar code given as a corporate identification number, and the corporate identification number of the hospital 20 is transmitted to the management server 31 from the PC 21. In case where image data of the bar code is given as the corporate identification number, the data can be preliminarily stored in the PC 11 to be transmitted to the management server 31.

The management server 31 of the data management institution 30 checks whether or not the two received identification numbers (i.e., the personal identification number and the corporate identification number) are registered. If the two identification numbers are registered in the management server 31, the management server 31 transmits medical data pertaining to the patient A to the hospital 20. If one or both of the two identification numbers is determined not to be registered, a request for acquiring medical data is denied, and refusal of the request is reported to the hospital 20. Further, the refusal of the request is also transmitted to the portable cellular phone 40.

In the embodiment, the data management institution 30 is to transmit medical data. However, the invention is not limited to the embodiment; for example, the hospital 20 may download the medical data pertaining to the patient A stored in the management server 31.

After the hospital 20 has acquired the medical data pertaining to the patient A in the previously-mentioned manner, medical examination and treatment of the patient A are performed by reference to the medical data. The medical data prepared by the hospital 20 are again stored in and managed by the management server 31 through use of the personal identification number and the corporate identification number.

The previously-described operation for ascertaining contents of medical data by the patient A may be performed before transmission of medical data to the hospital 20.

As mentioned above, the only requirement for performing safe and simple storage and acquisition of medical data is that a patient carry a commonly-used portable cellular phone.

When medical data are exchanged, security of medical data is ensured more reliably by means of encrypting the medical data. In the embodiment, the identification number is converted into a bar code. However, the invention is not limited to the embodiment; for example, an identification number consisting of alphanumerics can be used in its unmodified form. In this case, the patient or the hospital enters an identification number by way of a PC without use of a bar code reader.

If the portable cellular phone 40 has been lost or changed to another mode, the patient A informs the data management institution 30 of loss or change of the portable cellular phone 40, thereby temporarily halting transmission of medical data. Subsequently, exchange of the medical data pertaining to the patient A is initiated after re-issuance (re-registration) of the personal identification number.

In addition to a hospital, an eyeglass shop or a drug store where a doctor's prescription is to be used may acquire a corporate identification number from the data management institution 30 and required medical data (here, only a prescription) from the data management institution 30. In this case, the patient A goes to an eyeglass shop or a drug store without carrying a prescription and acquires his/her prescription by use of a communication terminal set in an individual facility. As a result, the patient A does not need to carry a prescription; and the patient merely needs to carry the portable cellular phone 40.

In the embodiment, the personal identification number is issued to the patient A. However, for instance, a corporate identification number is issued to a corporation. When an employee belonging to the corporation requests the data management institution 30 to issue a personal identification number, a personal identification number associated with the corporate identification number acquired by the corporation may be issued. In this case, a communication terminal (PC) owned by the corporation or a portable communication terminal of the employee can be employed in order to ascertain whether or not the employee has undergone mass health screening, such as a medical checkup or health examination, or to acquire the results of a medical checkup.

In the embodiment, a bar code is provided in the form of image data. However, the invention is not limited to the embodiment; for instance, the bar code may be taken as character string data. Alternatively, transmission and reception of identification information and medical data to and from an individual communication terminal, including a portable cellular phone, may be performed through use of data encryption or a Steganography technique.

As has been described, the invention obviates a necessity for a patient to carry a material (medium) having medical data stored therein, such as an IC card, and enables safe sharing of medical data among a plurality of medical institutions. Further, a patient can ascertain by himself/herself medical data to be recorded, thereby inhibiting storage of erroneous medical data.

What is claimed is:

1. A medical data management method comprising the steps of:
providing a personal identification information to a portable communication terminal of a patient via a communications channel; and
determining whether or not medical data of the patient, received from a communication terminal of a medical institute via the communications channel, can be accepted, based on the personal identification information and a corporate identification information received in association therewith.

2. The method of claim 1, further comprising the step of:
providing the corporate identification information to the communications terminal of the medical institute via the communications channel.

3. The method of claim 1, further comprising the steps of:
sending a confirmation information for confirming acceptance of the medial data, to the portable communication terminal of the patient via the communications channel in case it is determined that the received medical data can be accepted; and
accepting and storing the received medical data in case an information that permits the acceptance of the medical data is received from the portable communication terminal of the patient via the communications channel.

4. The method of claim 3, further comprising the step of:
returning the received medical data to the communication terminal of the medical institute via the communications channel in case an information that does not permit the acceptance of the medical data is received from the portable communication terminal of the patient via the communications channel.

5. The method of claim 1, further comprising the step of:
in case it is determined that the received medical data cannot be accepted, sending an information indicative of that determination to at least one of the communication terminal of the medical institute and the portable communication terminal of the patient via the communications channel.

6. A medical data management system comprising a computer in which a software programmed to execute the medial data management method of claim 1 is installed.

7. A medical data management method comprising the steps of:
providing a personal identification information to a portable communication terminal of a patient via a communications channel; and
determining whether or not stored and managed medical data of the patient can be sent to a communication terminal of a medical institute via the communications channel, based on the personal identification information and a corporate identification information received from the communication terminal of the medical institute via the communications channel.

8. The method of claim 7, further comprising the step of:
providing the corporate identification information to the communication terminal of the medical institute via the communications channel.

9. The method of claim 7, further comprising the steps of:
sending a confirmation information for confirming sending of the stored and managed medical data, to the portable communication terminal of the patient via the communications channel in case it is determined that the stored and managed medical data can be sent; and
sending the stored and managed medical data to the communication terminal of the medical institute via the communications channel in case an information that permits the sending of the medical data is received from the portable communication terminal of the patient via the communications channel.

10. The method of claim 9, further comprising the step of:
in case an information that refuses the sending of the medical data is received from the portable communication terminal of the patient, sending an information indicative of refusal to the communication terminal of the medical institute via the communications channel.

11. The method of claim 7, further comprising the step of:
in case it is determined that the stored and managed medical data cannot be sent, sending an information indicative of that determination to at least one of the communication terminal of the medical institute and the portable communication terminal of the patient via the communications channel.

12. A medical data management system comprising a computer in which a software programmed to execute the medical data management method of claim 7 is installed.

13. A medical data management system comprising:
first providing means for providing a personal identification information to a portable communication terminal of a patient via a communications channel;
determining means for determining whether or not medical data of the patient, received from a communication terminal of a medical institute via the communications channel, can be accepted, based on the personal identification information and a corporate identification information received in association therewith; and
managing means for storing and managing the received medical data of the patient in association with the personal identification information.

14. The system of claim 13, further comprising:
second providing means for providing the corporate identification information to the communication terminal of the medical institute via the communications channel.

15. The system of claim 13, further comprising:
sending means for sending a confirmation information for confirming acceptance of the medial data, to the portable communication terminal of the patient via the communications channel in case it is determined that the received medical data can be accepted,
wherein the managing means stores and manages the received medical data in case an information that permits the acceptance of the medical data is received from the portable communication terminal of the patient via the communications channel.

16. A medical data management system comprising:
first providing means for providing a personal identification information to a portable communication terminal of a patient via a communications channel;
determining means for determining whether or not stored and managed medical data of the patient can be sent to a communication terminal of a medical institute via the communications channel, based on the personal identification information and a corporate identification information received from the communication terminal of the medical institute via the communications channel; and
first sending means for sending the stored and managed medical data to the communication terminal of the medical institute via the communications channel.

17. The system of claim 16, further comprising the step of:
second providing means for providing the corporate identification information to the communication terminal of the medical institute via the communications channel.

18. The system of claim 16, further comprising the steps of:
second sending means for sending a confirmation information for confirming sending of the stored and managed medical data, to the portable communication terminal of the patient via the communications channel in case it is determined that the stored and managed medical data can be sent,
wherein the first sending means sends the stored and managed medical data to the communication terminal of the medical institute via the communications channel in case an information that permits the sending of the medical data is received from the portable communication terminal of the patient via the communications channel.
